(19) United States
(12) Patent Application Publication
(10) Pub. No.: US 2018/0148044 A1
(43) Pub. Date: May 31, 2018

(54) HYBRID VEHICLE CONTROL APPARATUS

(71) Applicant: Toyota Jidosha Kabushiki Kaisha, Toyota-shi (JP)

(72) Inventor: Nobufusa KOBAYASHI, Anjo-shi (JP)

(73) Assignee: Toyota Jidosha Kabushiki Kaisha, Toyota-shi (JP)

(21) Appl. No.: 15/824,112

(22) Filed: Nov. 28, 2017

(30) Foreign Application Priority Data
Nov. 29, 2016 (JP) 2016-231854

(51) Int. Cl. B60W 20/50; F16H 61/12; B60W 10/06; B60K 6/547; B60K 6/445

(52) U.S. Cl. CPC B60W 20/50; F16H 61/12; F16H 2061/1264; B60K 6/547; B60K 6/445; B60W 10/06

(57) ABSTRACT

A control apparatus (80) for a hybrid vehicle (10; 200) provided with: a drive power source including an engine (14; 202) and a vehicle driving electric motor (MG2; MG); an automatic transmission (20; 210) having hydraulically operated coupling devices (CB); and a hydraulic pressure source for the coupling devices, which includes a mechanically operated oil pump (100) operated by the engine, and an electrically operated oil pump (104) operated by a pump driving electric motor (102), the automatic transmission having speed positions having respective different speed ratio values and established with engaging actions of the selected coupling devices through solenoid-operated valves (SL), the coupling devices being operated by hydraulic pressures generated by the electrically operated oil pump, in a motor drive mode in which the vehicle is driven by the vehicle driving electric motor while the engine is at rest. The control apparatus includes: an abnormality detecting portion (92) for detecting an abnormality of the engaging action of the coupling devices to establish one of the speed positions in which the vehicle is started in the motor drive mode; an emergency engine starting portion (94) for starting the engine to operate the mechanically operated oil pump when the abnormality is detected; and a temporary engagement canceling portion (98) for controlling the solenoid-operated valve for the above-indicated one coupling device such that the coupling device is brought into its released state, upon starting of the engine, the temporary engagement canceling portion controlling the solenoid-operated valve to restore the above-indicated one coupling device to its engaged state after starting of the engine.

This application claims priority from Japanese Patent Application No. 2016-231854 filed on Nov. 29, 2016, the disclosure of which is herein incorporated by reference in its entirety.

### FIELD OF THE INVENTION

The present invention relates generally to a control apparatus for a hybrid vehicle, and more particularly to a control of the hybrid vehicle upon an operation of a mechanically operated oil pump in the event of detection of an abnormality of a power transmitting state of an automatic transmission.

### BACKGROUND OF THE INVENTION

There is well known a control apparatus for a hybrid vehicle provided with: a drive power source including an engine and a vehicle driving electric motor; an automatic transmission having a plurality of hydraulically operated coupling devices; and a hydraulic pressure source for the hydraulically operated coupling devices, which includes a mechanically operated oil pump operated by the engine, and an electrically operated oil pump operated by a pump driving electric motor. The automatic transmission has a plurality of speed positions having respective different values of a speed ratio of its output speed with respect to its input speed, which speed positions are established with engaging actions of selected ones of the hydraulically operated coupling devices through solenoid-operated valves. The hydraulically operated coupling devices are operated by hydraulic pressures generated by the electrically operated oil pump, in a motor drive mode in which the hybrid vehicle is driven by the vehicle driving electric motor while the engine is at rest. The control apparatus includes: an abnormality detecting portion configured to detect an abnormality of a power transmitting state of the automatic transmission due to an abnormality of the engaging action of one of the hydraulically operated coupling devices which is operated to establish one of the speed positions of the automatic transmission in which the hybrid vehicle is started in the motor drive mode; and an emergency engine starting portion configured to start the engine to operate the mechanically operated oil pump, when the abnormality of the power transmitting state of the automatic transmission is detected by the abnormality detecting portion. JP-2009-108923A discloses an example of this type of control apparatus, which is configured to determine that the abnormality of the power transmitting state of the automatic transmission is caused by an abnormality of the electrically operated oil pump, if the abnormality is removed by starting of the engine by the emergency engine starting portion.

However, the hybrid vehicle control apparatus described above has a risk of generation of a shifting shock of the automatic transmission caused by abrupt generation of a vehicle drive force with an inertia force due to an abrupt engaging action of the above-indicated one hydraulically operated frictional coupling device, if a hydraulic pressure generated by the mechanically operated oil pump is applied to the relevant frictional coupling device as a result of starting of the engine by the emergency engine starting portion, during racing of an input speed of the automatic transmission due to the abnormality of the engaging action of the relevant frictional coupling device.

### SUMMARY OF THE INVENTION

The present invention was made in view of the background art described above. It is therefore an object of the present invention to provide a control apparatus for a hybrid vehicle, which can prevent generation of a shifting shock of an automatic transmission caused by abrupt generation of a vehicle drive force due to an abrupt engaging action of a hydraulically operated coupling device, upon starting of an engine to operate a mechanically operated oil pump due to detection of an abnormality of a power transmitting state of the automatic transmission.

The object indicated above is achieved according to the following modes of the present invention:

According to a first mode of the invention, there is provided a control apparatus for a hybrid vehicle provided with: a drive power source including an engine and a vehicle driving electric motor; an automatic transmission having a plurality of hydraulically operated coupling devices; and a hydraulic pressure source for the hydraulically operated coupling devices, which includes a mechanically operated oil pump operated by the engine, and an electrically operated oil pump operated by a pump driving electric motor, the automatic transmission having a plurality of speed positions having respective different values of a speed ratio of its output speed with respect to its input speed, which speed positions are established with engaging actions of selected ones of the hydraulically operated coupling devices through solenoid-operated valves, the hydraulically operated coupling devices being operated by hydraulic pressures generated by the electrically operated oil pump, in a motor drive mode in which the hybrid vehicle is driven by the vehicle driving electric motor while the engine is at rest, the control apparatus comprising: an abnormality detecting portion configured to detect an abnormality of a power transmitting state of the automatic transmission due to an abnormality of the engaging action of one of the hydraulically operated coupling devices which is operated to establish one of the speed positions of the automatic transmission in which the hybrid vehicle is started in the motor drive mode; an emergency engine starting portion configured to start the engine to operate the mechanically operated oil pump, when the abnormality of the power transmitting state of the automatic transmission is detected by the abnormality detecting portion; and a temporary engagement canceling portion configured to control the solenoid-operated valve for the above-described one hydraulically operated coupling device placed in its engaged state to establish the above-described one speed position, such that the above-described one hydraulically operated coupling device is brought into its released state, upon starting of the engine by the emergency engine starting portion, the temporary engagement canceling portion controlling the solenoid-operated valve to restore the above-described one hydraulically operated coupling device to its engaged state after starting of the engine.

According to a second mode of the invention, the control apparatus according to the first mode of the invention further comprises an abnormality cause determining portion configured to determine that the abnormality of the power transmitting state of the automatic transmission is caused by a defect of the electrically operated oil pump, where the abnormality is removed by starting of the engine by the emergency engine starting portion.

The control apparatus according to the first mode of the invention is configured such that the solenoid-operated valve for the above-described one hydraulically operated coupling device placed in its engaged state to establish the above-described one speed position is controlled such that the above-described one hydraulically operated coupling device is brought into its released state, upon starting of the engine by the emergency engine starting portion. Then, the solenoid-operated valve is controlled to restore the above-described one hydraulically operated coupling device to its engaged state after starting of the engine, namely, after a rise of the hydraulic pressure generated by the mechanically operated oil pump operated by the engine. Accordingly, it is possible to prevent an abrupt engaging action of the relevant coupling device with a supply of pressurized working fluid from the mechanically operated oil pump, and a shifting shock of the automatic transmission due to a vehicle drive force variation upon engagement of the relevant coupling device. Where the relevant coupling device is restored to the engaged state after the racing of the input speed of the automatic transmission is terminated, it is possible to smoothly increase the vehicle drive force by controlling torque of the vehicle driving electric motor after the relevant coupling device is restored to the engaged state. Where the coupling device is restored to the engaged state while the input speed is still racing, on the other hand, it is possible to prevent an abrupt increase of the vehicle drive force by controlling the hydraulic pressure applied to the relevant coupling device, so as to smoothly restore the coupling device to the engaged state.

According to the second mode of the invention, the abnormality cause determining portion determines that the abnormality of the power transmitting state of the automatic transmission is caused by the defect of the electrically operated oil pump, where the abnormality is removed by starting of the engine by the emergency engine starting portion. Accordingly, the defect of the electrically operated oil pump can be detected without a need of using a hydraulic pressure switch or sensor. Further, a fail-safe control to deal with the defect of the electrically operated oil pump can be quickly implemented with an operation of the mechanically operated oil pump by the started engine.

### BRIEF DESCRIPTION OF THE DRAWINGS

FIG. 1 is a schematic view showing an arrangement of a drive system of a hybrid vehicle to be controlled by a control apparatus according to the present invention, and major control portions of the control apparatus;

FIG. 2 is a table indicating a relationship between speed positions of a mechanically operated step-variable transmission portion of FIG. 1 and combinations of hydraulically operated frictional coupling devices placed in engaged states to establish the respective speed positions;

FIG. 3 is a collinear chart indicating a relationship among rotating speeds of rotary elements of an electrically controlled continuously variable transmission portion of FIG. 1 and the mechanically operated step-variable transmission portion;

FIG. 4 is a circuit diagram of a hydraulic control unit incorporating clutches C1 and C2 and brakes B1 and B2 of the mechanically operated step-variable transmission portion;

FIG. 5 is a view illustrating an example of a shifting map used by a transmission shifting control portion of FIG. 1 to control shifting actions of the mechanically operated step-variable transmission portion, and a drive-power-source switching map;

FIG. 6 is a flow chart illustrating a control routine executed by an emergency control portion of FIG. 1;

FIG. 7 is a time chart illustrating an example of changes of various parameters when an emergency control is implemented according to the control routine illustrated in the flow chart of FIG. 6; and

FIG. 8 is a schematic view showing an arrangement of another type of a vehicular drive system different from that of FIG. 1, which is to be controlled by the control apparatus according to the present invention.

### DETAILED DESCRIPTION OF PREFERRED EMBODIMENTS

The engine provided as the drive power source is a gasoline engine, a diesel engine, or any other internal combustion engine which generates a drive power by combustion of a fuel. The vehicle driving electric motor also used as the drive power source is preferably a motor/generator which can be used also as an electric generator. The automatic transmission having a plurality of hydraulically operated coupling devices may be the above-described step-variable transmission of a planetary gear type or a permanent-meshing type parallel two-axes type transmission. This automatic transmission is disposed in a power transmitting path at least between the electric motor and vehicle drive wheels, and is configured to transmit a rotary motion of the vehicle driving electric motor to the drive wheels, at a selected one of speed ratios during the motor drive mode. The mechanically operated oil pump is directly connected to and operated by the engine, but may be disposed in a power transmitting path connected to the engine, such that the pump is operated by the engine as a drive power source.

The solenoid-operated valves provided to control the engaging and releasing actions of the hydraulically operated coupling devices are preferably linear solenoid-operated valves which control hydraulic pressure to change continuously, but may be on-off solenoid-operated valves that are selectively placed in on and off states. The on-off solenoid-operated valves can generate output pressures that are continuously variable by their duty ratio control, and permit smooth engaging actions of the hydraulically operated coupling devices.

Abnormalities of the power transmitting state of the automatic transmission due to abnormality of engaging actions of the hydraulically operated coupling devices can be detected on the basis of, for example, a difference between a theoretical value and an actual value of the speed ratio of a vehicle starting speed position of the automatic transmission, a degree of racing of the input speed of the automatic transmission, and a difference between rotating speeds of two rotary members of the hydraulically operated coupling devices. The abnormalities of the engaging actions of the hydraulically operated coupling devices may be abnormalities of releasing actions or slipping actions of the coupling devices that should be brought into the engaged state. The above-described temporary engagement canceling portion is provided to control the solenoid-operated valve to cancel the engaging action of the hydraulically operated coupling device upon starting of the engine by the above-described emergency engine starting portion. This temporary engagement canceling portion is preferably configured to cancel the engaging action of the coupling device prior to the starting of the engine. However, the temporary engagement canceling portion is at least required to cancel the engaging action of the coupling device at latest before a moment of initiation of generation of a hydraulic pressure by the mechanically operated oil pump operated by the started engine, namely, before a moment of initiation of the engaging action abruptly implemented by the generated hydraulic pressure. Re-engagement of the coupling device after starting of the engine is at least required to be effected by raising the hydraulic pressure of the coupling device after the moment of generation of the hydraulic pressure by the mechanically operated oil pump, namely, more specifically, after the rise of the hydraulic pressure to a value at which the engaging action can be implemented with high stability. The re-engagement of the coupling device can be rapidly implemented when the input speed of the automatic transmission is zero. When the input speed is in a racing state, the re-engagement is preferably effected after the racing has been reduced with the input speed being substantially zeroed. However, a risk of generation of a shifting shock of the automatic transmission can be reduced by slowly raising the hydraulic pressure of the coupling device, even in the racing state of the input speed.

Preferred embodiments of the present invention described below include (a) all-power-off speed-position establishing circuit configured to mechanically establish the above-described vehicle starting speed position of the automatic transmission in an all-power-off state in which all electric powers relating to hydraulic controls are in a shutoff state, and (b) an emergency all-power-off control portion configured to establish the all-power-off state where the abnormality of the power transmitting state of the automatic transmission is not removed in spite of starting of the engine by the emergency engine starting portion. The preferred embodiments are further configured such that (c) the above-described abnormality cause determining portion determines that the abnormality of the power transmitting state of the automatic transmission is caused by a defect of the solenoid-operated valve relating to the hydraulically operated coupling device the engaging action of which is implemented to establish the vehicle starting speed position of the automatic transmission, where the abnormality is removed in the all-power-off state established by the emergency all-power-off control portion. However, it is noted that the control apparatus according to the present invention does not necessarily include the all-power-off speed-position establishing circuit and the emergency all-power-off control portion.

### First Embodiment

Referring to the drawings, the preferred embodiments of the present invention will be described in detail.

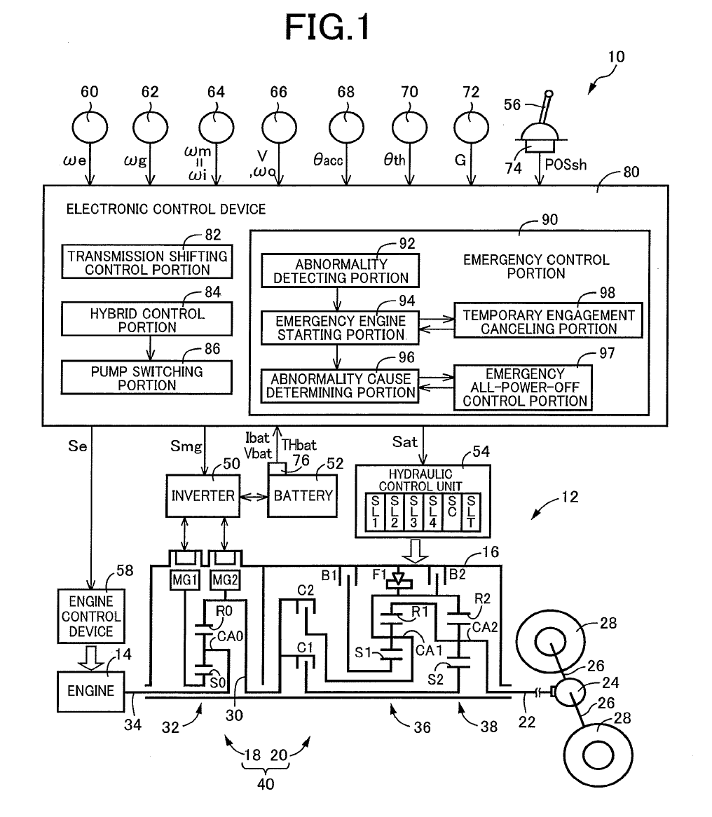

Reference is first made to FIG. 1, which is the schematic view showing an arrangement of a drive system 12 of a hybrid vehicle 10 to be controlled by a control apparatus according to the present invention, and major portions of the control apparatus to perform various controls of the hybrid vehicle 10. As shown in FIG. 1, the vehicular drive system 12 is provided with an engine 14, an electrically controlled continuously variable transmission portion 18 (hereinafter referred to as “continuously variable transmission portion 18”) connected directly or indirectly via a damper (not shown) or any other device to the engine 14, and a mechanically operated step-variable transmission portion 20 (hereinafter referred to as “step-variable transmission portion 20) connected to an output rotary member of the continuously variable transmission portion 18. The continuously variable transmission portion 18 and the step-variable transmission portion 20 are disposed in series with each other within a transmission casing 16 (hereinafter referred to as “casing 16”) functioning as a stationary member fixed to a body of the hybrid vehicle 10, such that the transmission portions 18 and 20 are disposed coaxially with each other on a common axis. The vehicular drive system 12 is further provided with a differential gear mechanism 24 connected to an output rotary member of the step-variable transmission portion 20 in the form of an output shaft 22, and a pair of axles 26 connected to the differential gear mechanism 24. In the vehicular drive system 12, a drive force (“drive torque” or “drive power” unless otherwise distinguished from the drive force) of the engine 14 and a second motor/generator MG2 (described below) is transmitted to the step-variable transmission portion 20, and is transmitted from the step-variable transmission portion 20 to drive wheels 28 of the hybrid vehicle 10 through the differential gear mechanism 24 and other devices. The vehicular drive system 12 is suitably used in the hybrid vehicle 10 of an FR type (front-engine rear-drive type) in which the axis of the engine 14 is parallel to the longitudinal direction of the hybrid vehicle 10. It is noted that the continuously variable transmission portion 18 and the step-variable transmission portion 20 are constructed substantially symmetrically with each other about the axis of the engine 14 (about the above-indicated common axis), and that FIG. 1 does not show the lower halves of the transmission portions 18 and 20.

The engine 14 is a drive power source to drive the hybrid vehicle 10, which is a known internal combustion engine such as a gasoline engine or a diesel engine. An engine torque Te which is an output torque of this engine 14 is controlled by an electronic control device 80 (described below) which controls the operating condition of the engine 14 as represented by an opening angle of a throttle valve or an intake air quantity, an amount of injection of a fuel and an ignition timing. In the present embodiment, the engine 14 is connected to the continuously variable transmission portion 18, without a fluid-operated type power transmitting device such as a torque converter or a fluid coupling being disposed between the engine 14 and the transmission portion 18.

The continuously variable transmission portion 18 is provided with: a first motor/generator MG1; a differential mechanism 32 functioning as a power distributing device to mechanically distribute the drive force of the engine 14 to the first motor/generator MG1, and to an intermediate power transmitting member 30 which is an output rotary member of the continuously variable transmission portion 18; and the second motor/generator MG2 operatively connected to the intermediate power transmitting member 30. The continuously variable transmission portion 18 is an electrically controlled differential portion and an electrically controlled continuously variable transmission, wherein a differential state of the differential mechanism 32 is controllable by controlling an operating state of the first motor/generator MG1. The first motor/generator MG1 functions as a differential motor/generator while the second motor/generator MG2 is an electric motor which functions as a drive power source, namely, a vehicle driving motor/generator. The hybrid vehicle 10 is provided with the drive power source in the form of the engine 14 and the second motor/generator MG2.

Each of the first motor/generator MG1 and the second motor/generator MG2 is an electrically operated rotary device having a function of an electric motor and a function of an electric generator. The first motor/generator MG1 and the second motor/generator MG2 are connected to an electric power storage device in the form of a battery 52 through an inverter 50. The inverter 50 provided on the hybrid vehicle 10 is controlled by the control apparatus in the form of the above-indicated electronic control device 80 described below in detail, to control an output torque (regenerative torque) of the first motor/generator MG1, namely, an MG1 torque Tg, and an output torque (forward driving torque) of the second motor/generator MG2, namely, an MG2 torque Tm. The battery 52 also provided on the hybrid vehicle 10 is the electric power storage device to and from which an electric power is supplied from and to the first motor/generator MG1 and the second motor/generator MG2.

The differential mechanism 32 is a planetary gear set of a single-pinion type having three rotary elements in the form of a sun gear S0, a carrier CA0 and a ring gear R0 in a differentially rotatable manner. The carrier CA0 is operatively connected to the engine 14 through a connecting shaft 34 in a power transmittable manner, and the sun gear S0 is operatively connected to the first motor/generator MG1 in a power transmittable manner, while the ring gear R0 is operatively connected to the second motor/generator MG2 in a power transmittable manner. In the differential mechanism 32, the carrier CA0 functions as an input rotary element, and the sun gear S0 functions as a reaction rotary element, while the ring gear R0 functions as an output rotary element.

The step-variable transmission portion 20 is a step-variable transmission which constitutes a part of a power transmitting path between the intermediate power transmitting member 30 and the drive wheels 28. The intermediate power transmitting member 30 also functions as an input rotary member of the step-variable transmission portion 20 (as a transmission input rotary member). The step-variable transmission portion 20 is considered to also constitute a part of a power transmitting path between the second motor/generator MG2 and the drive wheels 28, since the second motor/generator MG2 is connected to the intermediate power transmitting member 30 such that the intermediate power transmitting member 30 is rotated together with the second motor/generator MG2. The step-variable transmission portion 20 is a known automatic transmission of a planetary gear type which is provided with a plurality of planetary gear sets in the form of a first planetary gear set 36 and a second planetary gear set 38, and a plurality of coupling devices in the form of a clutch C1, a clutch C2, a brake B1 and a brake B2 (hereinafter referred to as “coupling devices CB” unless otherwise specified).

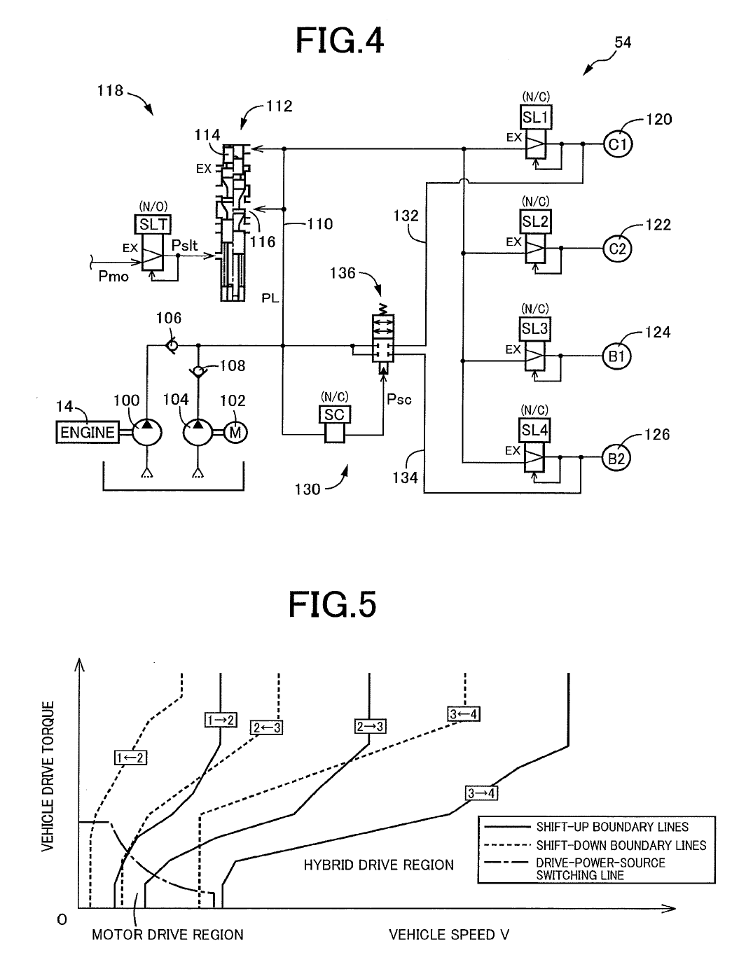

Each of the coupling devices CB is a hydraulically operated frictional coupling device in the form of a multiple-disc type or a single-disc type clutch or brake that is operatively pressed by a hydraulic actuator, or a band brake that is operatively tightened by a hydraulic actuator. Each of the coupling devices CB is selectively placed in engaged, slipped or released states with their torque capacities (engaging torque values) Tcb being changed according to engaging hydraulic pressures Pcb applied thereto, which are regulated by respective linear solenoid-operated valves SL1-SL4 (shown in FIG. 4) incorporated within a hydraulic control unit 54 provided in the hybrid vehicle 10.

In the step-variable transmission portion 20, selected ones of rotary elements (sun gears S1 and S2, carriers CA1 and CA2, and ring gears R1 and R2) of the first and second planetary gear sets 36 and 38 are connected to each other or to the intermediate power transmitting member 30, casing 16 or output shaft 22, either directly or indirectly (selectively) through the coupling devices CB or a one-way clutch F1.

The step-variable transmission portion 20 is shifted to a selected one of a plurality of (four in this embodiment) speed positions by engaging actions of selected ones of the coupling devices CB. These four AT speed positions have respective different speed ratios γat (=AT input speed ωi/AT output speed ωo). The AT input speed ωi is a rotating speed (angular velocity) of the input rotary member of the step-variable transmission portion 20, which is equal to a rotating speed of the intermediate power transmitting member 30, and which is also equal to an MG2 speed ωm which is an operating speed of the second motor/generator MG2. Thus, the AT input speed ωi can be represented by the MG2 speed ωm. The AT output speed ωo is a rotating speed of the output shaft 22 of the step-variable transmission portion 20, which is considered to be an output speed of a transmission device 40 which consists of the continuously variable transmission portion 18 and the step-variable transmission portion 20.

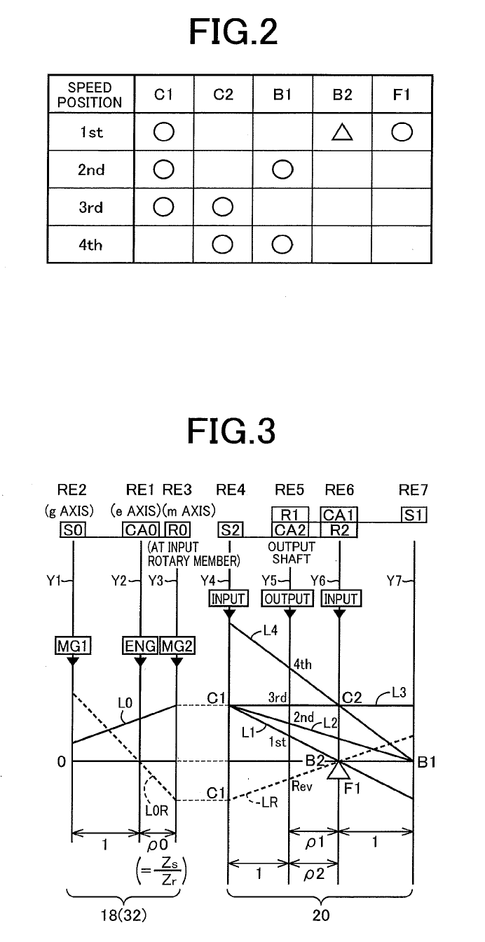

Reference is now made to FIG. 2, which is the table indicating the relationship between the first through fourth speed positions of the step-variable transmission portion 20 shown in FIG. 1 and combinations of the coupling devices CB placed in the engaged states to establish the respective speed positions. In the table, the four forward drive speed positions are respectively represented by “1^{st}”, “2^{nd}”, “3^{rd}” and “4^{th}”. The first speed position “1^{st}” has a highest speed ratio γat, and the speed ratios γat of the four speed positions decrease in the direction from the first speed position (lowest speed position) “1^{st}” toward the fourth speed position (highest speed position)“4^{th}”. In the table, “O” indicates the engaged state of the coupling devices CB, “Δ” indicates the engaged state of the coupling device B2 during application of an engine brake to the hybrid vehicle 10 or during a shift-down action of the step-variable transmission portion 20 while the hybrid vehicle 10 is in a coasting run, while the blank indicates the released state of the coupling devices CB. The one-way clutch F1 indicated above is disposed in parallel to the brake B2 which is placed in the engaged state to establish the first speed position “1^{st}”, so that the brake B2 is not required to be placed in the engaged state upon starting or acceleration of the hybrid vehicle 10. It is noted that the step-variable transmission portion 20 is placed in a neutral position (a power transmission cutoff state) when all of the coupling devices CB are placed in the released states.

The step-variable transmission portion 20 is shifted up or down to establish a newly selected one of the four speed positions, according to an operation amount θacc of an accelerator pedal and a vehicle running speed V, with a releasing action of one of the coupling devices CB and a concurrent engaging action of another coupling device CB, which concurrent releasing and engaging actions are controlled by the above-indicated electronic control device 80. The above-indicated one coupling device CB is a releasing-side coupling device which was placed in the engaged state before the step-variable transmission portion 20 is shifted to establish the newly selected speed position, while the above-indicated another coupling device CB is an engaging-side coupling device which is placed in the engaged state while the step-variable transmission portion 20 is placed in the newly selected speed position. Thus, the step-variable transmission portion 20 is shifted up or down from one of the speed positions to another by so-called “clutch-to-clutch” shifting operation, namely, concurrent releasing and engaging actions of the selected two coupling devices CB. For instance, the step-variable transmission portion 20 is shifted down from the second speed position “2^{nd}” to the first speed position “1^{st}”, with the releasing action of the brake B1 and the concurrent engaging action of the brake B2, as indicated in the table of FIG. 2. In this respect, it is noted that the first speed position “1^{st}” is established in the engaged states of the clutch C1 and the brake B2, while the brake B2 is placed in the released state in the second speed position “2^{nd}”, so that the brake B2 is brought into the engaged state to shift down the step-variable transmission portion 20 to from the second speed position “2^{nd}” to the first speed position “1^{st}”. In this instance, the hydraulic pressures applied to the brakes B1 and B2 are transiently controlled according to predetermined patterns to bring these brakes B1 and B2 into the released and engaged states, respectively.

FIG. 4 is the circuit diagram of the hydraulic control unit 54 incorporating the linear solenoid-operated valves SL1-SL4 for controlling the engaging and releasing actions of the coupling devices CB. The hydraulic control unit 54 includes a mechanically operated oil pump 100 operated by the engine 14, and an electrically operated oil pump (EOP) 104 operated by a pump driving electric motor 102, which are provided as a hydraulic pressure source for the coupling devices CB. The pump driving electric motor 102 is operated according to an EOP operating command of hydraulic control command signals Sat generated from the electronic control device 80. A pressurized working fluid delivered from those oil pumps 100 and 104 is fed to a line pressure passage 110 through respective check valves 106 and 108, and a pressure of the working fluid in the line pressure passage 110 is regulated to a predetermined line pressure PL by a line pressure control valve 112, which is a primary regulator valve, for example. A linear solenoid-operated valve SLT, which is connected to the line pressure control valve 112, is electrically controlled by the electronic control device 80, to convert a substantially constant modulator pressure Pmo into a pilot pressure Pslt. This pilot pressure Pslt is applied to the line pressure control valve 112, so that a spool 114 of the line pressure control valve 112 is biased by the pilot pressure Pslt, and is axially moved, whereby a cross-sectional area of opening of a port communicating with a drain passage 116 is changed, so that the line pressure PL is regulated according to the pilot pressure Pslt. This line pressure PL is regulated according to a required vehicle drive force as represented by the accelerator pedal operation amount θacc. The linear solenoid-operated valve SLT indicated above is an electromagnetic pressure regulating valve to be used for regulating the line pressure, and the line pressure control valve 112 is a hydraulic pressure control valve to regulate the line pressure PL according to the pilot pressure Pslt received from the linear solenoid-operated valve SLT. A line pressure regulating device 118 is constituted principally by the line pressure control valve 112 and the linear solenoid-operated valve SLT.

The linear solenoid-operated valve SLT described above is of a normally-open (MO) type, so that the modulator pressure Pmo is generated as the pilot pressure Pslt, when the linear solenoid-operated valve SLT is placed in a de-energized state due to its electric wire disconnection, for example. In this case, the line pressure PL generated from the line pressure control valve 112 is comparatively high. In the event of sticking of a spool of the linear solenoid-operated valve SLT in the presence of a foreign matter therein, for example, in the event of an on-state sticking abnormality (on-fail) in which the pilot pressure Pslt is held at its lowest value, the spool 114 of the line pressure control valve 112 is moved to its lowest position as seen in FIG. 4, at which the port communicating with the drain passage 116 has the largest cross sectional area of opening, so that the line pressure PL is kept at its lowest value PLmin.

The pressurized working fluid having the line pressure PL regulated by the line pressure regulating device 118 is supplied to the linear solenoid-operated valves SL1-SL4, etc. through the line pressure passage 110. The linear solenoid-operated valves SL1-SL4 are held in communication with respective hydraulic actuators (hydraulic cylinders) 120, 122, 124 and 126 of the respective clutches and brakes C1, C2, B1 and B2, and output pressures (engaging hydraulic pressures Pcb) of the linear solenoid-operated valves SL1-SL4 are controlled according to engaging/releasing commands (indicative of solenoid energizing electric currents) of the hydraulic control command signals Sat received from the electronic control device 80, so that the clutches and brakes C1, C2, B1 and B2 are individually placed in their engaged or released state, to selectively establish one of the first speed position “1^{st}” through the fourth speed position “4^{th}” of the step-variable transmission portion 20. Each of the linear solenoid-operated valves SL1-SL4 is of a normally-closed (N/C) type, so that the supply of the pressurized working fluid to the hydraulic actuators 120, 122, 124 and 126 is shut off, when the respective linear solenoid-operated valves SL1-SL4 are placed in a de-energized state due to its electric wire disconnection, for example. In this case, the clutches and brakes C1, C2, B1 and B2 cannot be brought into their engaged state. The linear solenoid-operated valves SL1-SL4 are solenoid-operated valves provided to selectively place the clutches and brakes C1, C2, B1 and B2 in their engaged state according to the hydraulic control command signals Sat received from the electronic control device 80.

The hydraulic control unit 54 incorporates an all-power-off speed-position establishing circuit 130 configured to mechanically establish the above-described first speed position “1^{st}” of the step-variable transmission portion 20 in an all-power-off state in which all electric powers relating to the hydraulic controls are in a shut-off state. The all-power-off speed-position establishing circuit 130 includes bypass passages 132 and 134 disposed in parallel with the linear solenoid-operated valves SL1 and SL4, and a two-position switching valve 136 to selectively place the bypass passages 132 and 134 in their fluid-communication and non-fluid-communication states. The bypass passage 132 is provided for fluid communication between the line pressure passage 110 and the hydraulic actuator 120 for the clutch C1, while bypassing the linear solenoid-operated valve SL1. The bypass passage 134 is provided for fluid communication between the line pressure passage 110 and the hydraulic actuator 126 for the brake B2, while bypassing the linear solenoid-operated valve SL4. The line pressure PL is applied to the hydraulic actuators 120 and 126 through the respective bypass passages 132 and 134, to establish the first speed position “1^{st}”. A pilot pressure Psc is applied from an on-off solenoid-operated valve SC to the two-position switching valve 136, so that the two-position switching valve 136 is brought into its shut-off position in which both of the bypass passages 132 and 134 are placed in their non-fluid-communication state indicated in FIG. 4. When the application of the pilot pressure Psc to the two-position switching valve 136 is shut off, the two-position switching valve 136 is returned to its fluid-communication position in which both of the bypass passages 132 and 134 are placed in their fluid-communication state due to the spring. The on-off solenoid-operated valve SC is of a normally-closed (N/C) type, so that when the on-off solenoid-operated valve SC is placed in its energized state, the pilot pressure Psc is generated from this on-off solenoid-operated valve SC, whereby the two-position switching valve 136 is placed in its shut-off position. When the on-off solenoid-operated valve SC is placed in its de-energized state, the generation of the pilot pressure Psc is shut off, so that the two-position switching valve 136 is placed in its fluid-communication position. However, the on-off solenoid-operated valve SC is normally held in its open state in which the pilot pressure Psc is generated. Accordingly, when the on-off solenoid-operated valve SC is normally placed in its energized state, both of the bypass passages 132 and 134 are placed in their non-fluid-communication state, so that the clutch C1 and the brake B2 are selectively brought into their engaged and released states according to respective engaging hydraulic pressures Pc1 and Pb2 received from the respective linear solenoid-operated valves SL1 and SL4. In the all-power-off state, on the other hand, both of the bypass passages 132 and 134 are placed in their fluid-communication state, so that the clutch C1 and the brake B2 are both brought into their engaged state to establish the first speed position “1^{st}”, whereby the vehicle 10 can be run in the first speed position “1^{st}”, to a suitable place for safety. The linear solenoid-operated valve SLT of the line pressure regulating device 118 is of a normally-open (N/O) type, so that the line pressure PL is suitably controlled to a predetermined value by the line pressure control valve 112, even in the all-power-off state. It is noted that the bypass passage 134 may be removed from the hydraulic control unit 54. In this case, only the clutch C1 is brought into its engaged state with the engaging hydraulic pressure Pa received through the bypass passage 132, to establish the first speed position “1^{st}”. In the present embodiment, the hydraulic control unit 54 is controlled according to the present invention upon starting of the vehicle 10 in a motor drive mode in the all-power-off state, for instance, while the step-variable transmission portion 20 is placed in the first speed position “1^{st}”. However, the present invention is applicable to the control of the hydraulic control unit 54 upon starting of the vehicle 10 in the motor drive mode in the all-power-off state while the step-variable transmission portion 20 is placed in the second speed position “2^{nd}” or any other low-speed position other than the first speed position “1^{st}”.

The collinear chart of FIG. 3 indicates the relationship among rotating speeds of the rotary elements of the continuously variable transmission portion 18 and the step-variable transmission portion 20. In this collinear chart, three vertical lines Y1, Y2 and Y3 corresponding to the respective three rotary elements of the differential mechanism 32 of the continuously variable transmission portion 18 respectively represent a “g” axis representing the rotating speed of the second rotary element RE2 in the form of the sun gear S0, an “e” axis representing the rotating speed of the first rotary element RE1 in the form of the carrier CA0, and an “m” axis representing the rotating speed of the third rotary element RE3 in the form of the ring gear R0 (i.e., the input speed of the step-variable transmission portion 20). Further, four vertical lines Y4, Y5, Y6 and Y7 corresponding to the respective four rotary elements of the step-variable transmission portion 20 respectively represent an axis representing the rotating speed of the fourth rotary element RE4 in the form of the sun gear S2, an axis representing the rotating speed of the fifth rotary element RE5 in the form of the ring gear R1 and the carrier CA2 fixed to each other, namely, the rotating speed of the output shaft 22, an axis representing the rotating speed of the sixth rotary element RE6 in the form of the carrier CA1 and the ring gear R2 fixed to each other, and an axis representing the rotating speed of the seventh rotary element RE7 in the form of the sun gear S1. The distances between the adjacent ones of the vertical lines Y1, Y2 and Y3 are determined by a gear ratio (tooth number ratio) ρ0 of the differential mechanism 32, while the distances between the adjacent ones of the vertical lines Y4-Y7 are determined by gear ratios ρ1 and ρ2 of the respective first and second planetary gear sets 36 and 38. Where the distance between the axis representing the rotating speed of the sun gear S and the axis representing the rotating speed of the carrier CA corresponds to “1” in the planetary gear sets of the single-pinion type, the distance between the axis representing the rotating speed of the carrier CA and the axis representing the rotating speed of the ring gear R corresponds to the gear ratio ρ of the planetary gear set (=number of teeth Zs of the sun gear/number of teeth Zr of the ring gear).

Referring to the collinear chart of FIG. 3, the differential mechanism 32 of the continuously variable transmission portion 18 is arranged such that the engine 14 (represented as “ENG” in the collinear chart) is connected to the first rotary element RE1, and the first motor/generator MG1 (represented as “MG1” in the collinear chart) is connected to the second rotary element RE2, while the second motor/generator MG2 (represented as “MG2” in the collinear chart) is connected to the third rotary element RE3 which is rotated together with the intermediate power transmitting member 30. Thus, a rotary motion of the engine 14 is transmitted to the step-variable transmission portion 20 through the intermediate power transmitting member 30. In a part of the collinear chart corresponding to the continuously variable transmission portion 18, straight lines L0 and L0R intersecting the vertical line Y2 represent a relationship among the rotating speeds of the sun gear S0, carrier CA0 and ring gear R0.

The step-variable transmission portion 20 is arranged such that the fourth rotary element RE4 is selectively connected to the intermediate power transmitting member 30 through the clutch C1, the fifth rotary element RE5 is connected to the output shaft 22, the sixth rotary element RE6 is selectively connected to the intermediate power transmitting member 30 through the clutch C2 and is selectively connected to the casing 16 through the brake B2, and the seventh rotary element RE7 is selectively connected to the casing 16 through the brake B1. In a part of the collinear chart corresponding to the step-variable transmission portion 20, straight lines L1, L2, L3, L4 and LR intersecting the vertical line Y5 represent a relationship among the rotating speeds of the rotary elements RE4-RE7 in the respective first, second, third and fourth speed positions “1^{st}”, “2^{nd}”, “3^{rd}” and “4^{th}” and the reverse drive position “Rev”, which are selectively established with selective engaging and releasing actions of the coupling devices CB.

Solid straight lines L0, L1, L2, L3 and L4 shown in the collinear chart of FIG. 3 indicate the relative rotating speeds of the rotary elements in a hybrid drive mode (HEY drive mode) in which the hybrid vehicle 10 is driven in the forward direction with at least the engine 14 being operated as a drive power source. In the differential mechanism 32 and in the hybrid drive mode, when a torque Te of the engine 14 (engine torque Te) is applied to the carrier CA0 while a reaction torque which is a negative torque generated by the first motor/generator MG1 operated in the positive direction is applied to the sun gear S0, a directly transmitted engine torque Td (=Te/(1+φ=−(1/φ*Tg) which is a positive torque is applied to the ring gear R0, whereby the ring gear R0 is rotated in the positive direction with the engine torque Td. The hybrid vehicle 10 is driven in the forward direction with a vehicle drive torque which is a sum of the directly transmitted engine torque Td and the MG2 torque Tm and which is transmitted to the drive wheels 28 through the step-variable transmission portion 20 selectively placed in one of the first through fourth speed positions according to a required vehicle drive force. At this time, the first motor/generator MG1 functions as an electric generator operated in the positive direction, and generates a negative torque. An electric power Wg generated by the first motor/generator MG1 is stored in the battery 52 or consumed by the second motor/generator MG2. The second motor/generator MG2 is operated to generate the MG2 torque Tm, with all or a part of the electric power Wg generated by the first motor/generator MG1, or a sum of the generated electric power Wg and the electric power supplied from the battery 52.

In the differential mechanism 32 and in the motor drive mode (EV drive mode) in which the hybrid vehicle 10 is driven with a drive force generated by the second motor/generator MG2 operated as a drive power source while the engine 14 is held at rest, the carrier CA0 is held stationary while the MG2 torque Tm which is a positive torque is applied to the ring gear R0, whereby the ring gear R0 is rotated in the positive direction with the MG2 torque Tm. In this motor drive mode, the state of the differential mechanism 32 is not shown in the collinear chart of FIG. 3. At this time, the first motor/generator MG1 connected to the sun gear S0 is placed in a non-load state and freely operated in the negative direction. Namely, in the motor drive mode, the engine 14 is held in non-operated state, so that an operating speed we of the engine 14 (engine speed we) is kept zero, and the hybrid vehicle 10 is driven in the forward direction with the MG2 torque Tm (positive forward driving torque), which is transmitted as a forward drive torque to the drive wheels 28 through the step-variable transmission portion 20 placed in one of the first through fourth speed positions.

Broken straight lines L0R and LR indicated in FIG. 3 indicate relative rotating speeds of the rotary elements during a reverse running of the hybrid vehicle 10 in the motor drive mode. When the hybrid vehicle 10 is driven in the rearward direction in this motor drive mode, the MG2 torque Tm which is a negative torque is applied to the ring gear R0, and rotates the ring gear R0 in the negative direction, and is transmitted as a rear drive torque of the hybrid vehicle 10 to the drive wheels 28 through the step-variable transmission portion 20 placed in the first speed position. As described below, the electronic control device 80 controls the second motor/generator MG2 to permit the hybrid vehicle 10 to be driven in the rearward direction with the MG2 torque Tm generated while the step-variable transmission portion 20 is placed in the forward-drive low-speed position in the form of the first speed position which is one of the first through fourth speed positions. The above-indicated MG2 torque Tm is a reverse drive torque Tm of the second motor/generator MG2 (a negative torque generated with an operation of the second motor/generator MG2 in the negative direction, which is specifically referred to as “MG2 torque TmR”) which is opposite in the direction of its transmission to a forward drive torque Tm of the second motor/generator MG2 (a positive torque generated with an operation of the second motor/generator MG2 in the positive direction, which is specifically referred to as “MG2 torque TmF”). Thus, the hybrid vehicle 10 to be controlled by the electronic control device is driven in the rearward direction by operating the second motor/generator MG2 in the negative direction to generate the negative torque Tm while the step-variable transmission portion 20 is placed in the forward-drive position (which is also used to drive the hybrid vehicle 10 in the forward direction). Namely, the step-variable transmission portion 20 may not comprise a reverse drive position in which the direction of the output rotary member is reversed with respect to the direction of the input rotary member, and which is used only for driving in rearward direction. It is noted that the hybrid vehicle 10 can be driven in the rearward direction in the hybrid drive mode as well as in the motor drive mode, since the second motor/generator MG2 can be operated in the negative direction, with the engine 14 being kept operated in the forward direction, as indicated by the straight line L0R.

In the vehicular drive system 12, the continuously variable transmission portion 18 functions as an electrically controlled shifting mechanism (electrically controlled differential mechanism) provided with the differential mechanism 32 the differential state of which is controlled by controlling the operating state of the first motor/generator MG1 provided as the differential electric motor (differential motor/generator), and which has the three rotary elements, that is, the first rotary element RE1 in the form of the carrier CA0 to which the engine 14 is operatively connected in a power transmittable manner, the second rotary element RE2 in the form of the sun gear S0 to which the first motor/generator MG1 is operatively connected in a power transmittable manner, and the third rotary element RE3 in the form of the ring gear R0 to which the intermediate power transmitting member 30 is connected (in other words, to which the second motor/generator MG2 provided as the vehicle driving electric motor (vehicle driving motor/generator) is operatively connected) in a power transmittable manner. Namely, the continuously variable transmission portion 18 has the differential mechanism 32 to which the engine 14 is operatively connected in a power transmittable manner, and the first motor/generator MG1 to which the differential mechanism 32 is operatively connected in a power transmittable manner, and the operating state of which is controlled to control the differential state of the differential mechanism 32. The continuously variable transmission portion 18 is operated as an electrically controlled continuously variable transmission a speed ratio γ0 (=ωe/ωm) of which is continuously variable. The speed ratio γ0 is a ratio of rotating speed of the connecting shaft 34 (namely, engine speed we) to the rotating speed of the intermediate power transmitting member 30 (namely, MG2 speed ωm).

In the hybrid drive mode, for instance, the rotating speed of the sun gear S0 is raised or lowered by controlling operating speed of the first motor/generator MG1 while the rotating speed of the ring gear R0 is determined by rotating speed of the drive wheels 28 with the step-variable transmission portion 20 placed in one of the speed positions, so that the rotating speed of the carrier CA0 (namely, engine speed we) is accordingly raised or lowered. For running of the hybrid vehicle 10 with an operation of the engine 14, therefore, the engine 14 can be operated at an efficient operating point. That is, the step-variable transmission portion 20 to be placed in a selected one of the speed positions and the continuously variable transmission portion 18 functioning as a continuously variable transmission cooperate to provide the transmission device 40 which functions as a continuously variable transmission as a whole. A speed ratio γt of the transmission device 40 as a whole, that is, an overall speed ratio γt of the continuously variable transmission portion 18 and the step-variable transmission portion 20 which are disposed in series with each other is a product (γ0*γat) of the speed ratio γ0 of the continuously variable transmission portion 18 and the speed ratio γat of the step-variable transmission portion 20.

Referring back to FIG. 1, the hybrid vehicle 10 is provided with the control apparatus in the form of the electronic control device 80 configured to control various devices of the hybrid vehicle 10 such as the engine 14, continuously variable transmission portion 18 and step-variable transmission portion 20. FIG. 1 is the view showing input and output signals of the electronic control device 80, and is a functional block diagram showing major control functions and control portions of the electronic control device 80. For example, the electronic control device 80 includes a so-called microcomputer incorporating a CPU, a ROM, a RAM and an input-output interface. The CPU performs control operations of the hybrid vehicle 10, by processing various input signals, according to control programs stored in the ROM, while utilizing a temporary data storage function of the RAM. The electronic control device 80 may be constituted by two or more control units exclusively assigned to perform different control operations such as engine control operations and transmission shifting control operations. The electronic control device 80 corresponds to the control apparatus of the hybrid vehicle 10.

The electronic control device 80 receives various input signals such as: an output signal of an engine speed sensor 60 indicative of the engine speed ωe; an output signal of an MG1 speed sensor 62 indicative of the MG1 speed ωg which is the operating speed of the first motor/generator MG1; an output signal of an MG2 speed sensor 64 indicative of the MG2 speed ωm which is the AT input speed ωi; an output signal of an output speed sensor 66 indicative of the output speed ωo corresponding to the vehicle running speed V; an output signal of an accelerator pedal operation amount sensor 68 indicative of the operation amount θacc of the accelerator pedal, which operation amount θacc represents a degree of acceleration of the hybrid vehicle 10 required by a vehicle operator; an output signal of a throttle valve opening angle sensor 70 indicative of an angle θth of opening of an electronic throttle valve; an output signal of an acceleration sensor 72 indicative of a longitudinal acceleration value G of the hybrid vehicle 10; an output signal of a shift position sensor 74 indicative of a presently selected operating position POSsh of a manually operated shifting member in the form of a shift lever 56 provided in the hybrid vehicle 10; and output signals of a battery sensor 76 indicative of a temperature THbat, a charging/discharging electric current Ibat and a voltage Vbat of the battery 52. Further, the electronic control device 80 generates various output signals such as: an engine control command signal Se to be applied to an engine control device 58 provided to control a throttle actuator, a fuel injecting device and an ignition device, for controlling the engine 14; motor/generator control command signals Smg to be applied to the inverter 50, for controlling the first motor/generator MG1 and the second motor/generator MG2; and the above-described hydraulic control command signals Sat to be applied to the hydraulic control unit 54, for controlling the operating state of the pump driving electric motor 102 and the operating states of the coupling devices CB (namely, for controlling the shifting actions of the step-variable transmission portion 20). The hydraulic control command signals Sat are command signals (drive currents) to be applied to the hydraulic control unit 54 for controlling amounts of electric currents to be applied to the linear solenoid-operated valves SL1-SL4 which regulate the engaging hydraulic pressure Pcb to be applied to each of the hydraulic actuators 120-126 of the coupling devices CB. The electronic control device 80 operates to set a hydraulic pressure command value (command pressure) corresponding to the engaging hydraulic pressure Pcb to be applied to each of the hydraulic actuators 120-126, and outputs a drive current corresponding to the hydraulic pressure command value.

The presently selected operating position POSsh of the shift lever 56 is one of: a parking position P; a reverse drive position R; a neutral position N; and a forward drive position D, for example. The parking position P is a position which is established while the transmission device 40 is placed in a neutral state (in which the step-variable transmission portion 20 is placed in a non-power transmittable state with all of the coupling devices CB placed in their released state) and in which the output shaft 22 is mechanically locked to prevent its rotary motion, for thereby holding the transmission device 40 in a parking brake position. The reverse drive position R is a position in which the transmission device 40 is placed in a rear drive state in which the hybrid vehicle 10 can be driven in the rearward direction with the MG2 torque TmR while the step-variable transmission portion 20 is placed in the first speed position “1^{st}”. The neutral position N is a position in which the transmission device 40 is placed in the above-indicated neutral state. The forward drive position D is a position in which the transmission device 40 is placed in a forward drive state in which the hybrid vehicle 10 can be driven in the forward direction according to an automatic shifting control to selectively establish one of all of the first through fourth speed positions “1^{st}” through “4^{th}”. Therefore, when the shift lever 56 is switched from the forward drive position D to the rear drive position R, the transmission device 40 is commanded to be switched from its forward drive state to the rear drive state (, namely, to perform a switching action from the forward drive state to the rear drive state). Thus, the manually operated shift lever 56 functions as a manually operated member for commanding the transmission device 40 in a selected one of its operating states describe above.

The electronic control device 80 is configured to calculate a charging state (stored electric power amount) SOC of the battery 52 on the basis of the charging/discharging electric current Ibat and the voltage Vbat of the battery 52. The electronic control device 80 is further configured to calculate, on the basis of, for example, the temperature THbat and the charging state SOC of the battery 52, a maximum charging amount Win of electric power that can be stored in the battery 52, and a maximum discharging amount Wout of electric power that can be discharged from the battery 52, which maximum charging and discharging amounts Win and Wout define a range of an electric power of the battery 52 that can be used. The calculated maximum charging and discharging amounts Win and Wout decrease with a decrease of the battery temperature THbat when the battery temperature THbat is lower than a normal level, and decrease with an increase of the battery temperature THbat when the battery temperature THbat is higher than the normal level. Further, the maximum charging amount Win decreases with an increase of the stored electric power amount SOC when the stored electric power amount SOC is relatively large. The maximum discharging amount Wout decreases with a decrease of the stored electric power amount SOC when the stored electric energy amount SOC is relatively small.

The electronic control device 80 includes transmission shifting control means in the form of a transmission shifting control portion 82, hybrid control means in the form of a hybrid control portion 84, pump switching means in the form of a pump switching portion 86 and emergency control means in the form of an emergency control portion 90, for performing various controls of the hybrid vehicle 10.

The transmission shifting control portion 82 is configured to determine a shifting action of the step-variable transmission portion 20 according to a predetermined shifting map, and applies the hydraulic control command signals Sat to the hydraulic control unit 54, to implement a shifting control of the step-variable transmission portion 20 for commanding the linear solenoid-operated valves SL1-SL4 to bring the appropriate ones of the coupling devices CB into the released and engaged states, to automatically shift up or down the step-variable transmission portion 20. The shifting map indicated above denotes a shifting condition defined by a predetermined relationship between a required vehicle drive torque (represented by accelerator pedal operation amount θacc, throttle valve opening angle θth or required vehicle drive power Pdem) and the vehicle running speed V, as shown in FIG. 5. The shifting map is formulated such that the speed ratio γat of the speed position to which the step-variable transmission portion 20 is shifted decreases with an increase of the vehicle running speed V and increases with an increase of the vehicle drive torque. Solid lines in FIG. 5 are shift-up boundary lines while broken lines are shift-down boundary lines. A predetermined amount of hysteresis is provided between the shift-up and shift-down boundary lines.

The hybrid control portion 84 has a function of an engine control means or portion to control the engine 14, and a function of a motor/generator control means or portion to control the first motor/generator MG1 and the second motor/generator MG2 through the inverter 50. Thus, the hybrid control portion 84 performs hybrid drive controls for controlling the engine 14, first motor/generator MG1 and second motor/generator MG2. For example, the hybrid control portion 84 calculates a required vehicle drive power Pdem on the basis of the accelerator pedal operation amount θacc and the vehicle running speed V, and generates the command signals (engine control command signal Se and motor/generator control command signals Smg) to control the engine 14, first motor/generator MG1 and second motor/generator MG2, so as to provide the calculated required vehicle drive power Pdem, while taking account of the maximum charging and discharging amounts Win and Wout of electric power of the battery 52. When the transmission device 40 as a whole is operated as the continuously variable transmission while the continuously variable transmission portion 18 is operated as the continuously variable transmission, for instance, the hybrid control portion 84 controls the engine 14 and the electric power amount Wg to be generated by the first motor/generator MG1, so as to establish the engine speed ωe and the engine torque Te for obtaining an engine power Pe to establish the required vehicle drive power Pdem, while taking account of a highest fuel economy point of the engine 14, so that the speed ratio γ0 of the continuously variable transmission portion 18 is controlled so as to be continuously varied. As a result, the speed ratio γt of the transmission device 40 is controlled while the continuously variable transmission portion 18 is operated as the continuously variable transmission.

The hybrid control portion 84 is further configured to establish the motor drive mode according to a predetermined drive-power-source switching map, during running of the vehicle with a comparatively small vehicle drive torque and at a comparatively low running speed V, in which an operating efficiency of the engine 14 is comparatively low. In the motor drive mode, only the second motor/generator MG2 is used as the drive power source while the engine 14 is held at rest. A one-dot chain line in FIG. 5 represents an example of the drive-power-source switching map, which defines a boundary between the motor drive region and the hybrid drive region in a two-dimensional coordinate system in which the vehicle running speed V is taken along one axis while the required vehicle drive torque is taken along another axis. The motor drive region is a region in which the vehicle running speed V is comparatively low while the vehicle drive torque is comparatively low. When the running state of the hybrid vehicle 10 falls within the motor drive region, the hybrid vehicle 10 is driven in the motor drive mode. On the other hand, the hybrid drive region is a region in which the vehicle running speed V is comparatively high while the vehicle drive torque is comparatively large. When the running state of the hybrid vehicle 10 falls within the hybrid drive region, the hybrid vehicle 10 is driven in the hybrid drive mode in which the engine 14 is operated. Even in the hybrid drive mode in which the engine 14 is operated, a torque assisting control is implemented as needed, to add a drive torque generated by the second motor/generator MG2, to the drive torque generated by the engine 14. The second motor/generator MG2 is operated (performs its vehicle driving operation) with an electric energy generated by the first motor/generator MG1 during its regenerative operation, and an electric energy supplied from the battery 52, so that the vehicle drive torque generated by the second motor/generator MG2 is transmitted to the drive wheels 28. That is, the torque assisting control is implemented as needed, even when the vehicle running state falls within the hybrid drive region in FIG. 5. Further, even when the vehicle running state falls within the motor drive region in FIG. 5, the hybrid drive mode is established where the electric power amount SOC stored in the battery 52 and the maximum discharging amount Wout are smaller than predetermined threshold values. When the vehicle drive mode is changed from the motor drive mode to the hybrid drive mode, the engine 14 is started by cranking with a rise of the engine speed ωe by the first motor/generator MG1, for example, irrespective of whether the hybrid vehicle 10 is running or held stationary.

The pump switching portion 86 is configured to operate the pump driving electric motor 102 for operating the electrically operated oil pump 104 to delivery the pressurized working fluid. Described more specifically, when the vehicle drive mode is changed to the motor drive mode by the hybrid control portion 84, and the engine 14 is brought into the non-operated state, the mechanically operated oil pump 100 is held at rest and the pressurized working fluid cannot be delivered from the oil pump 100, so that the hydraulic control command signals Sat are generated to operate the pump driving electric motor 102 to operate the electrically operated oil pump 104.

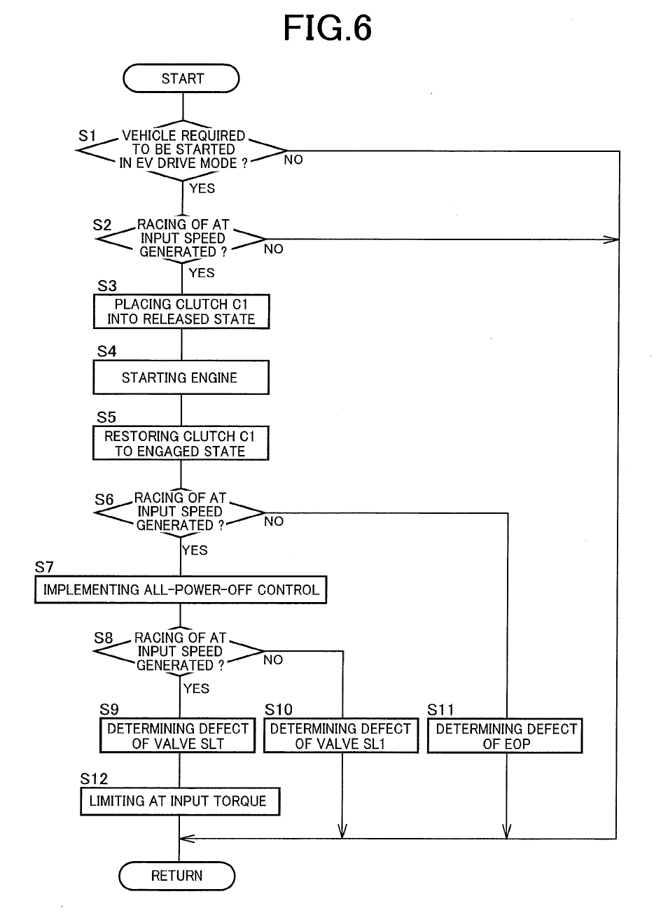

The emergency control portion 90 is configured to implement a fail-safe control for enabling the hybrid vehicle 10 to be run to a suitable place for safety, and to determine defective components, in the event of generation of an abnormality of the engaging action of any coupling device CB due to abnormality of any of the linear solenoid-operated valves SLT and SL1-SL4 of the hydraulic control unit 54, or the pump driving electric motor 102, for example. This emergency control portion 90 includes abnormality detecting means in the form of an abnormality detecting portion 92, emergency engine starting means in the form of an emergency engine starting portion 94, abnormality cause determining means in the form of an abnormality cause determining portion 96, emergency all-power-off control means in the form of an emergency all-power-off control portion 97, and temporary engagement canceling means in the form of a temporary engagement canceling portion 98. The emergency control portion 90 performs a signal processing operation according to steps S1-S12 of a control routine illustrated in the flow chart of FIG. 6. It is noted that the steps S1 and S2 correspond to the abnormality detecting portion 92, and the step S4 corresponds to the emergency engine starting portion 94, while the step S7 corresponds to the emergency all-power-off control portion 97, and that the steps SG and S8-S11 correspond to the abnormality cause determining portion 96, and the steps S3 and S5 correspond to the temporary engagement canceling portion 98.

The control routine of FIG. 6 is initiated with the step S1 to determine whether the hybrid vehicle 10 is required to be started in the EV drive mode, that is, in the motor drive mode. Described more specifically, this determination can be made by determining whether the vehicle driving operation of the second motor/generator MG2 is started with the engine 14 being held at rest, which vehicle driving operation is performed as a result of an operation of the shift lever 56 to a forward drive position D, or a releasing operation of a brake pedal to its non-operated position or a depressing operation of the accelerator pedal (to increase its operation amount θacc) with the forward drive position D being selected, while the hybrid vehicle 10 is stationary with its vehicle running speed V being substantially zero. It is considered that the vehicle driving operation of the second motor/generator MG2 may include an operation where a torque to move the hybrid vehicle 10 in a creeping manner is generated as a result of the operation of the shift lever 56 to the forward drive position D or the releasing operation of the brake pedal. If a negative determination is obtained in the step S1, one cycle of execution of the control routine is terminated. If an affirmative determination is obtained in the step S1, the control flow goes to the step S2. In the step S2, a determination is made as to whether a racing (temporary increase) of the AT input speed ωi or the MG2 speed ωm is generated while the AT output speed ωo is substantially zero. The racing is a rise of the AT input speed ωi or the MG2 speed ωm above a predetermined value. The generation of the racing indicates generation of an abnormality of the power transmitting state of the step-variable transmission portion 20, namely, an abnormality of the state of power transmission through the clutch C1 to be placed in the engaged state to establish the first speed position “1^{st}” in which the hybrid vehicle 10 is started. That is, the generation of the racing means an abnormality of the engaging action of the clutch C1. When the clutch C1 is placed in the fully engaged state to establish the first speed position “1^{st}”, a product (ωo*γat1) of the AT output speed ωo and a theoretical speed ratio γat1 of the first speed position “1^{st}” is substantially equal to the actual AT input speed on. Therefore, the determination as to whether the racing of the AT input speed ωi is generated or not can be made according to the following equation (1). That is, it is possible to determine that the racing is generated due to an abnormal engaging action of the clutch C1, if the AT input speed ωi is equal to or higher than a sum (ωo*γat1+X) of the product (ωo*γat1) of the AT output speed ωo and the theoretical speed ratio γat1 and a margin value X. Although the hybrid vehicle 10 is started in the first speed position “1^{st}” in this embodiment, the hybrid vehicle 10 may be started in the second speed position “2^{nd}” or any other low-speed position other than the first speed position “1^{st}”.

ωi≥ωo*γat1+X (1)

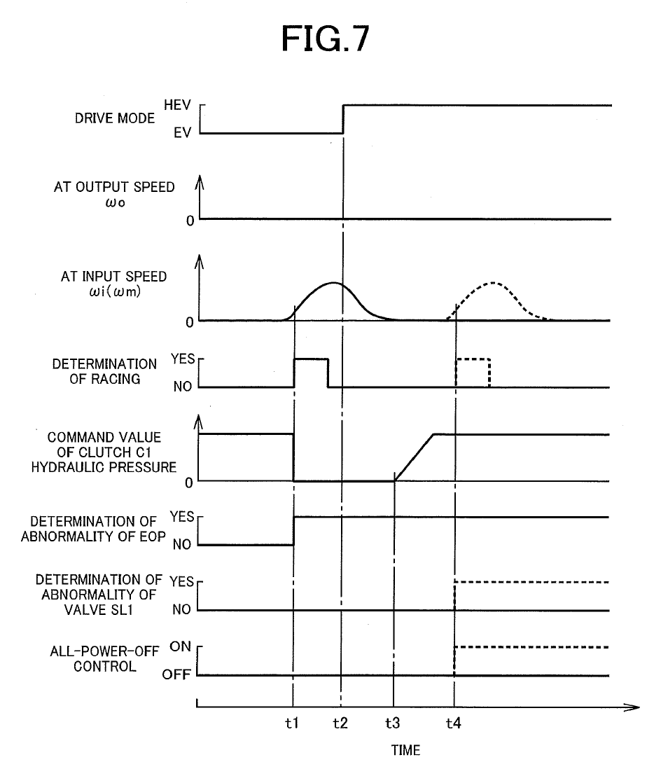

If a negative determination is obtained in the step S2, one cycle of execution of the control routine is terminated. If an affirmative determination is obtained in the step S2, that is, if an abnormality of the power transmitting state of the step-variable transmission portion 20 is detected by the abnormality detecting portion 92 in the step S2, the control flow goes to the steps S3-S5 to control the linear solenoid-operated valve SL1 so as to place the clutch C1 into the released state, then start the engine 14, and subsequently control the linear solenoid-operated valve SL1 so as to restore the clutch C1 to the engaged state. Namely, where the racing of the AT input speed ωi is generated at a point of time t1 as indicated in the time chart of FIG. 7, it is initially regarded that the electrically operated oil pump (EOP) 104 has an abnormality (such as electric wire disconnection or removal of a wire connector of the pump driving electric motor 102), and the engine 14 is operated by the emergency engine starting potion 94 in the step S4, to operate the mechanically operated oil pump 100. If the linear solenoid-operated valve SL1 is placed in the state for applying the hydraulic pressure to the clutch C1 to place the clutch C1 in the engaged state, the clutch C1 is abruptly brought into the engaged state with the supply of the pressurized working fluid thereto from the mechanically operated oil pump 100, upon starting of the engine 14 due to switching of the vehicle drive mode to the hybrid drive (HEV) mode at a point of time t2. If the racing of the AT input speed ωi is continued at this time, as indicated in the time chart, a vehicle drive force is suddenly generated due to an inertia, for example, giving rise to a risk of generation of a shifting shock of the step-variable transmission portion 20. To prevent this risk, the present embodiment is configured such that the linear solenoid-operated valve SL1 is controlled by the temporary engagement canceling portion 98 to bring the clutch C1 into the released state in the step S3 prior to starting of the engine 14, and to restore the clutch C1 to the engaged state in the step S5 after the racing is terminated with the AT input speed ωi being substantially zeroed after the engine 14 is started to raise the hydraulic pressure generated by the mechanically operated oil pump 100. Described more specifically, the engaging action of the clutch C1 is initiated by the linear solenoid-operated valve SL1 at a point of time t3, as indicated in the time chart of FIG. 7, and the engaging hydraulic pressure Pc1 of the clutch C1 is raised at a predetermined rate so that the clutch C1 is smoothly restored back to its engaged state, without generation of the shifting shock. In the example of FIG. 7, the hybrid vehicle 10 is started where a torque to move the hybrid vehicle 10 in a creeping manner is generated as a result of the operation of the shift lever 56 to the forward drive position D or the releasing operation of the brake pedal. As a result of the determination of generation of the racing of the AT input speed ωi, the vehicle driving operation of the second motor/generator MG2 is temporarily interrupted, and is resumed after termination of the engaging action of the clutch C1, to start the vehicle with the creeping torque. Even where the hybrid vehicle 10 is started as a result of an operation of the accelerator pedal by the vehicle operator, the clutch C1 can be restored to the engaged state after termination of the racing of the AT input speed ωi, by forcibly reducing the torque Tm of the second motor/generator MG2 when the racing occurs.

Then, the control flow goes to the step S6 to make the determination as to whether the racing of the AT input speed ωi is generated after the vehicle driving operation of the second motor/generator MG2 is resumed. This determination is made in the same manner as in the step S2. If a negative determination is obtained in the step S6, that is, if the clutch C1 is adequately brought into the engaged state with the operation of the mechanically operated oil pump 100, the control flow goes to the step S11 to determine that the cause for the abnormality is a defect of the electrically operated oil pump 104. A solid line in the time chart of FIG. 7 represents a case where the clutch C1 is adequately brought into the engaged state. In this case, a fail-safe control to deal with the abnormality of the electrically operated oil pump 104 is implemented by starting the engine 14 to operate the mechanically operated oil pump 100.

If an affirmative determination (YES) is obtained in the step S6, that is, if the racing of the AT input speed ωi is generated again, the control flow goes to the step S7 to implement an all-power-off control. In the all-power-off control, all electric powers relating to the hydraulic controls are shut off, so that the two-position switching valve 136 of the all-power-off gear-position establishing circuit 130 is switched to its fluid-communication position, to apply the line pressure PL to the clutch C1 and the brake B2 through the bypass passages 132 and 134, for thereby mechanically establishing the first speed position “1^{st}”. Broken lines in FIG. 7 represent the case where the determination that the racing is generated is made in the step S6 and the racing is generated at a point of time t4. In this case, it is determined that the linear solenoid-operated valve SL1 has an abnormality such as electric wire disconnection, and the all-power-off control is implemented in the step S7. “ON” in the graph of “ALL-POWER-OFF CONTROL” in FIG. 7 indicates that the all-power-off control is implemented, while “OFF” in the same graph indicates that the all-power-off control is not implemented.

The control flow then goes to the step S8 to make the determination as to whether the racing of the AT input speed ωi is generated. This determination is made in the same manner as in the step S2. If a negative determination is obtained in the step S8, that is, if the clutch C1 is adequately brought into the engaged state with implementation of the all-power-off control, the control flow goes to the step S10 to determine that the cause for the abnormality is a defect of the linear solenoid-operated valve SL1. In this case, a fail-safe control is implemented to deal with the abnormality of the linear solenoid-operated valve SL1 by the implementation of the all-power-off control.

If an affirmative determination (YES) is obtained in the step S8, that is, if the racing of the AT input speed ωi is generated again, the control flow goes to the step S9 to determine that the linear solenoid-operated valve SLT of the line pressure regulating device 118 has an abnormality. Namely, it is considered that the clutch C1 cannot be adequately brought into the engaged state even with the implementation of the all-power-off state, because the line pressure PL is abnormally low, and that the pilot pressure Pslt is abnormally low due to the on-fail of the linear solenoid-operated valve SLT such as valve spool sticking. In this case, the clutch C1 and the brake B1 are brought into the engaged state with the working fluid having a minimum value PLmin of the line pressure PL. However, the torque capacities of the clutch C1 and brake B1 are small, so that the fail-safe control is implemented in the step S12 to limit the drive power source torque, namely, the input torque of the step-variable transmission portion 20, to prevent slipping actions of the clutch C1 and brake B1. It is noted that in the event of the abnormality of the linear solenoid-operated valve SLT due to its valve spool sticking, the all-power-off control in the step S7 may be cancelled to drive the hybrid vehicle 10 with the step-variable transmission portion 20 placed in the appropriate two or more speed positions, while the drive power source torque is limited.

As described above, the electronic control device 80 according to the present embodiment provided as the control apparatus for the hybrid vehicle 10 is configured such that the linear solenoid-operated valve SL1 for the clutch C1 placed in its engaged state to establish the first speed position “1^{st}” is controlled in the step S3 such that the clutch C1 is brought into its released state, upon starting of the engine 14 by the emergency engine starting portion 94 in the step S4 and in the event of generation of racing of the AT input speed ωi during starting of the hybrid vehicle 10 in the motor drive mode. Then, the linear solenoid-operated valve SL1 is controlled in the step S5 to restore the clutch C1 to its engaged state after starting of the engine 14, namely, after a rise of the hydraulic pressure generated by the mechanically operated oil pump 100 operated by the engine 14. Accordingly, it is possible to prevent an abrupt engaging action of the clutch C1 with a supply of the pressurized working fluid from the mechanically operated oil pump 100, and a shifting shock of the step-variable transmission portion 20 due to a vehicle drive force variation upon engagement of the clutch C1. Further, since the clutch C1 is restored to the engaged state in the step S5 after the racing of the AT input speed ωi is terminated, it is possible to prevent the shifting shock generated when the clutch C1 is restored to the engaged state, and to smoothly increase the vehicle drive force by implementing the vehicle driving torque control of the second motor/generator MG2 after the clutch C1 is restored to the engaged state. In addition, the clutch C1 can be temporarily placed in the released state by simply controlling the linear solenoid-operated valve SL1, so that the electronic control device 80 can simply deal with the abnormality of the power transmitting state of the step-variable transmission portion 20, with minor changes of its control specifications.

The electronic control device 80 is further configured such that the abnormality cause determining portion 96 determines in the step S11 that the abnormality of the power transmitting state of the step-variable transmission portion 20, that is, the racing of the AT input speed (pi is caused by the defect of the electrically operated oil pump 104, where the abnormality is removed by starting of the engine 14 (where the negative determination is obtained in the step S6). Accordingly, the defect of the electrically operated oil pump 104 can be accurately detected without a need of using a hydraulic pressure switch or sensor. Further, a fail-safe control to deal with the defect of the electrically operated oil pump 104 can be quickly implemented with an operation of the mechanically operated oil pump 100 by the started engine 14.

If the abnormality of the power transmitting state of the step-variable transmission portion 20, namely, the racing of the AT input speed ωi is generated in spite of starting of the engine 14, that is, if the affirmative determination (YES) is obtained in the step S6, the all-power-off control is implemented in the step S7 so that the first speed position “1^{st}” is mechanically established by the all-power-off speed-position establishing circuit 130. Where the racing of the AT input speed ωi is terminated as a result of the all-power-off control, that is, if the negative determination (NO) is obtained in the step S8, the abnormality cause determining portion 96 determines in the step S10 that the abnormality of the power transmitting state is caused by the defect of the linear solenoid-operated valve SL1 for bringing the clutch C1 into the engaged state. Accordingly, the defect of the linear solenoid-operated valve SL1 can be accurately detected without a need of using a hydraulic pressure switch or sensor. Further, a fail-safe control to deal with the defect of the linear solenoid-operated valve SL1 can be quickly implemented with the all-power-off control. If the affirmative determination (YES) is obtained in the step S8, that is, if the racing of the AT input speed ωi is generated again, the abnormality cause determining portion 96 determines in the step S9 that the abnormality of the power transmitting state is caused by the defect of the linear solenoid-operated valve SLT of the line pressure regulating device 118. Accordingly, the defect of the linear solenoid-operated valve SLT can be accurately detected without a need of using a hydraulic pressure switch or sensor. Further, a fail-safe control to deal with the defect of the linear solenoid-operated valve SLT can be quickly implemented with the limitation in the following step S12 of the vehicle drive torque generated by the drive power source.

While the preferred embodiment of this invention has been described in detail by reference to the drawings, it is to be understood that the invention may be otherwise embodied.

### Second Embodiment

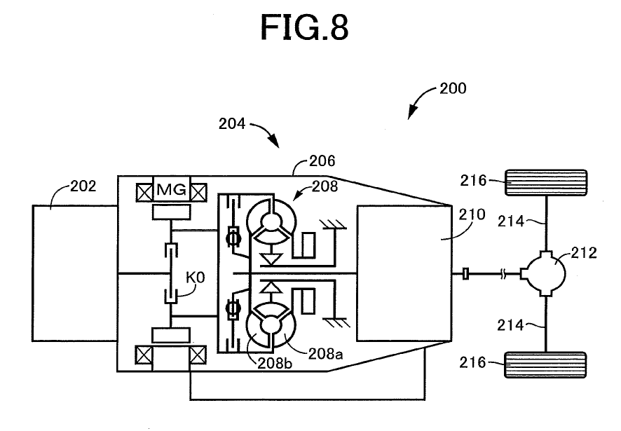

In the preceding first embodiment, the control apparatus is configured to control the hybrid vehicle 10 provided with the continuously variable transmission portion 18 and the step-variable transmission portion 20 which are disposed in series with each other. However, the control apparatus according to the present invention may be configured to control a hybrid vehicle 200 shown in FIG. 8. The hybrid vehicle 200 is provided with a vehicular drive system 204 including an engine 202 functioning as a vehicle drive power source, and a motor/generator MG which is an electric motor also functioning as the drive power source. The vehicular drive system 204 includes a clutch K0, a torque converter 208 and a mechanically operated step-variable transmission portion 210, which are disposed within a stationary member in the form of a transmission casing 206 fixed to a body of the hybrid vehicle 200, in this order of description as seen in the direction from the engine 202. The vehicular drive system 204 further includes a differential gear device 212 and axles 214. The torque converter 208 has a pump impeller 208a selectively connected to the engine 202 through the clutch K0 and directly connected to the motor/generator MG, and a turbine impeller 208b directly connected to the mechanically operated step-variable transmission portion 210. In the vehicular drive system 204, a drive force of the engine 202 and/or a drive force of the motor/generator MG are/is transmitted to drive wheels 216 through the clutch K0 (where the drive force of the engine 202 is transmitted), the torque converter 208, the mechanically operated step-variable transmission portion 210, the differential gear device 212 and the axles 214, in this order of description. The mechanically operated step-variable transmission portion 210 is a planetary gear type automatic transmission which has a plurality of hydraulically operated frictional coupling devices, and which has a plurality of speed positions that are established with engaging and releasing actions of the hydraulically operated frictional coupling devices.

The hybrid vehicle 200 described above can also be driven in the motor drive mode in which the motor/generator MG is operated while the engine 202 is held at rest with the clutch K0 held in the released state, and in the hybrid drive mode in which the engine 202 is operated. Further, the hybrid vehicle 200 is provided with a hydraulic control unit incorporating the mechanically operated oil pump 100, the electrically operated oil pump 104, a plurality of solenoid-operated valves for shifting of the mechanically operated step-variable transmission portion 210, and the all-power-off speed-position establishing circuit 130, which are shown in FIG. 4. The hybrid vehicle 200 is controlled by a control apparatus which is configured to implement emergency controls similar to those illustrated in the flow chart of FIG. 6, and which has substantially the same advantages as described above with respect to the first embodiment. The hydraulically operated frictional coupling device which is placed in the engaged state to establish the speed position in which the hybrid vehicle 200 is started is suitably selected in accordance with the structure of the mechanically operated step-variable transmission portion 210, and need not be the clutch C1.

In the illustrated first embodiment, the step-variable transmission portion 20 is an automatic transmission of a planetary gear type having the four forward drive speed positions. However, the step-variable transmission portion 20 need not have the four forward drive positions, as long as the step-variable transmission portion 20 has a plurality of speed positions each of which is selectively established with engagement of selected at least one of a plurality of coupling devices. That is, the step-variable transmission portion 20 which is an automatic transmission of the planetary gear type may be replaced by a known DCT (Dual Clutch Transmission) which is a synchronous meshing parallel two-axes type automatic transmission having two input shafts which are provided with respective coupling devices (clutches) and which are operatively connected to respective two shifting units having respective even-numbered speed positions and odd-numbered speed positions.

In the illustrated first embodiment, the differential mechanism 32 is the planetary gear set of the single-pinion type having the three rotary elements. However, the differential mechanism 32 may be replaced by a differential mechanism including a plurality of planetary gear sets which are connected to each other and which have four or more rotary elements. Alternatively, the differential mechanism 32 may be a planetary gear set of a double-pinion type. In the differential mechanism 32 in the first embodiment, the engine 14 is connected to the rotary element RE1 (carrier CA0) located in the middle of the collinear chart of FIG. 3. However, various modifications of the differential mechanism 32 may be made. For instance, the AT input rotary member (intermediate power transmitting member 30) may be connected to the rotary element located in the middle of the collinear chart of FIG. 3.

It is to be understood that the embodiments and modifications described above are given for illustrative purpose only, and that the present invention may be embodied with various other changes and improvements which may occur to those skilled in the art.

### NOMENCLATURE OF ELEMENTS

10, 200: Hybrid vehicle
14, 202: Engine (Drive power source)
20, 210: Mechanically operated step-variable transmission portion (Automatic transmission)
80: Electronic control device (Control apparatus)
92: Abnormality detecting portion
94: Emergency engine starting portion
96: Abnormality cause determining portion
98: Temporary engagement canceling portion
100: Mechanically operated oil pump
102: Pump driving electric motor
104: Electrically operated oil pump
MG2: Second motor/generator (Electric motor, drive power source)
MG: Motor/generator (Electric motor, drive power source)
C1, C2: Clutches (Hydraulically operated coupling devices)
B1, B2: Brakes (Hydraulically operated coupling devices)
SL1-SL4: Linear solenoid-operated valves (Solenoid-operated valves)
ωi: Transmission input speed (Input speed)
ωo: Output speed

What is claimed is:

1. A control apparatus for a hybrid vehicle provided with: a drive power source including an engine and a vehicle driving electric motor; an automatic transmission having a plurality of hydraulically operated coupling devices; and a hydraulic pressure source for the hydraulically operated coupling devices, which includes a mechanically operated oil pump operated by the engine, and an electrically operated oil pump operated by a pump driving electric motor, the automatic transmission having a plurality of speed positions having respective different values of a speed ratio of its output speed with respect to its input speed, which speed positions are established with engaging actions of selected ones of the hydraulically operated coupling devices through solenoid-operated valves, the hydraulically operated coupling devices being operated by hydraulic pressures generated by the electrically operated oil pump, in a motor drive mode in which the hybrid vehicle is driven by the vehicle driving electric motor while the engine is at rest, said control apparatus comprising:
an abnormality detecting portion configured to detect an abnormality of a power transmitting state of the automatic transmission due to an abnormality of the engaging action of one of the hydraulically operated coupling devices which is operated to establish one of the speed positions of the automatic transmission in which the hybrid vehicle is started in the motor drive mode;
an emergency engine starting portion configured to start the engine to operate the mechanically operated oil pump, when the abnormality of the power transmitting state of the automatic transmission is detected by the abnormality detecting portion; and
a temporary engagement canceling portion configured to control the solenoid-operated valve for said one hydraulically operated coupling device placed in its engaged state to establish said one speed position, such that said one hydraulically operated coupling device is brought into its released state, upon starting of the engine by the emergency engine starting portion, the temporary engagement canceling portion controlling the solenoid-operated valve to restore said one hydraulically operated coupling device to its engaged state after starting of the engine.

2. The control apparatus according to claim 1, further comprising an abnormality cause determining portion configured to determine that the abnormality of the power transmitting state of the automatic transmission is caused by a defect of the electrically operated oil pump, where the abnormality is removed by starting of the engine by the emergency engine starting portion.
